(19) United States
(12) Patent Application Publication
(10) Pub. No.: US 2019/0278632 A1
(43) Pub. Date: Sep. 12, 2019

(54) INFORMATION PROCESSING APPARATUS AND INFORMATION PROCESSING SYSTEM

(71) Applicant: FUJITSU LIMITED, Kawasaki-shi (JP)

(72) Inventor: Atsushi SAKAI, Yokohama (JP)

(73) Assignee: FUJITSU LIMITED, Kawasaki-shi (JP)

(21) Appl. No.: 16/293,970

(22) Filed: Mar. 6, 2019

(30) Foreign Application Priority Data
Mar. 9, 2018 (JP) 2018-043136

(51) Int. Cl. G06F 9/50; G06F 9/455

(52) U.S. Cl. CPC G06F 9/5077; G06F 9/5016; G06F 2009/45583; G06F 2009/4557; G06F 9/45558

(57) ABSTRACT

An information processing apparatus includes a first memory and a processor coupled to the first memory. The processor determines whether an additional storage amount requested by a virtual machine exceeds an allocatable storage amount for the virtual machine within a storage capacity of the first memory. The processor determines, in a case where it is determined that the additional storage amount exceeds the allocatable storage amount, whether it is possible to allocate a required storage amount from a second memory in another information processing apparatus. The required storage amount is equivalent to a shortage in storage amount in the first memory to fully allocate the additional storage amount. The processor requests the another information processing apparatus to allocate the required storage amount in a case where it is determined that it is possible to allocate the required storage amount from the second memory.

### CROSS-REFERENCE TO RELATED APPLICATION

This application is based upon and claims the benefit of priority of the prior Japanese Patent Application No. 2018-043136, filed on Mar. 9, 2018, the entire contents of which are incorporated herein by reference.

### FIELD

The embodiment discussed herein is related to an information processing apparatus and an information processing system.

### BACKGROUND

In an information processing system using a server virtualization technique, by making one or a plurality of virtual machines (VMs) run in a physical server, it is possible to integrate information processes carried out by a large number of physical servers among a small number of physical servers. A virtual machine monitor (VMM), which is software for virtualization, is installed in the physical server, and one or a plurality of VMs runs on the VMM. The VMM is also referred to as “hypervisor” in some cases.

Related to the virtualization technique, a method for allocating a central processing unit (CPU) and a memory in a virtual computer system is known.

Hereinafter, a “physical server” as hardware is simply described as a “server” in some cases.

Related techniques are disclosed in, for example, International Publication Pamphlet No. WO 2014/141419, Japanese Laid-open Patent Publication No. 11-316747, Japanese Laid-open Patent Publication No. 2008-243203, and U.S. Patent Application Publication No. 2016/0124774.

In a server in which a plurality of VMs operates, in a case where a storage amount of memory that is used by the VMs becomes insufficient, any one of the VMs is forcibly terminated in some cases.

Such an issue arises not only in a case where VMs run in a server but also in a case where VMs run in another information processing apparatus.

### SUMMARY

According to an aspect of the present invention, provided is an information processing apparatus including a first memory for storing data to be used by a virtual machine and a processor coupled to the first memory. The processor is configured to determine whether an additional storage amount requested by the virtual machine exceeds an allocatable storage amount for the virtual machine within a storage capacity of the first memory. The processor is configured to determine, in a case where it is determined that the additional storage amount exceeds the allocatable storage amount, whether it is possible to allocate a required storage amount from a second memory in another information processing apparatus. The required storage amount is equivalent to a shortage in storage amount in the first memory to fully allocate the additional storage amount. The processor is configured to request the another information processing apparatus to allocate the required storage amount in a case where it is determined that it is possible to allocate the required storage amount from the second memory.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a VM;

FIG. 2 is a functional configuration diagram of an information processing apparatus;

FIG. 3 is a flowchart of a control process;

FIG. 4 is a functional configuration diagram of an information processing system;

FIG. 5 is a diagram illustrating a storage area of memory;

FIG. 6 is a diagram illustrating a storage area in a state close to memory exhaustion;

FIG. 7 is a diagram illustrating a storage area in a state where memory exhaustion has occurred;

FIG. 8 is a diagram illustrating a storage area allocated to a VM;

FIG. 9 is a flowchart illustrating a specific example of a control process;

FIG. 10 is a diagram illustrating a reading-out control process;

FIG. 11 is a flowchart illustrating a reading-out control process;

FIG. 12 is a diagram illustrating a sequence of a reading-out control process;

FIG. 13 is a diagram illustrating a sequence of a writing-in control process;

FIG. 14 is a diagram illustrating update information;

FIG. 15 is a flowchart illustrating an update information generation process;

FIG. 16 is a diagram illustrating a live migration;

FIG. 17 is a flowchart of a periodic monitoring process; and

FIG. 18 is a hardware configuration diagram of an information processing apparatus.

### DESCRIPTION OF EMBODIMENT

Hereinafter, an embodiment will be described in detail with reference to the drawings.

In a server in which a plurality of VMs operates, when a memory exhaustion warning is issued, there is a case in which some of the VMs are forcibly terminated. This incident may occur mainly due to the following two causes.

(1) The storage amount of memory used by the VMs increases due to a rise in load of the processing carried out by the VMs. As a result, a memory exhaustion warning is issued in the server in which the plurality of VMs is disposed based on an assumption that low-load processing is to be carried out.

(2) The storage amount of memory is wastefully consumed due to a memory leak of a hypervisor running in the server so that the storage amount allowed to be used by the VMs is decreased. As a result, a memory exhaustion warning is issued.

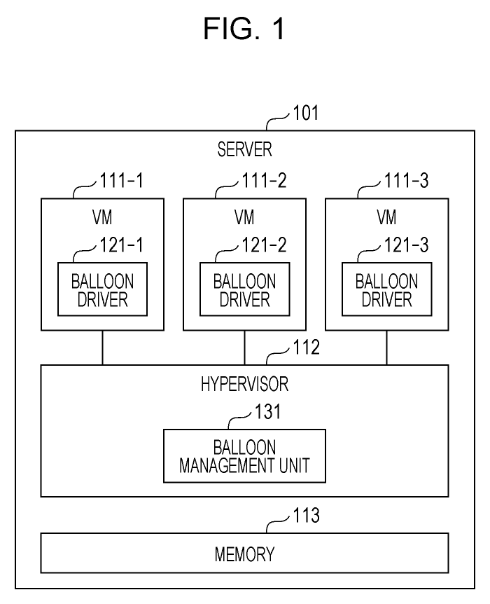

FIG. 1 illustrates an example of VMs running in a server. In a server 101, a VM 111-1 to a VM 111-3 and a hypervisor 112 are running. Each of the VMs 111-i (i=1 to 3) includes a balloon driver 121-i, and the hypervisor 112 includes a balloon management unit 131. The balloon management unit 131 allocates a storage amount of a memory 113 in the server 101 to the VM 111-i in response to a request from the balloon driver 121-i.

For example, in a case where a load of processing carried out by the VM 111-1 rises, the balloon driver 121-1 requests the balloon management unit 131 to allocate an additional storage amount to be used by the VM 111-1. The balloon management unit 131 checks an unused storage amount (remaining storage amount) of the memory 113 in the server 101, and in a case where the requested additional storage amount is equal to or smaller than the remaining storage amount, the balloon management unit 131 allocates the additional storage amount to the VM 111-1.

On the other hand, in a case where the additional storage amount exceeds the remaining storage amount, a memory exhaustion warning is issued, and any one of the VMs 111-1 to 111-3 is forcibly terminated.

In this manner, by the balloon management unit 131 dynamically allocating the storage amount of the memory 113, the storage amount may be interchanged among these VMs until the loads exerted on the VM 111-1 to the VM 111-3 reach a set value. However, in a case where the loads exceeding the set value are exerted on the VM 111-1 to VM 111-3, the storage amount of the memory 113 becomes insufficient so it is difficult for the processing to be carried out continuously.

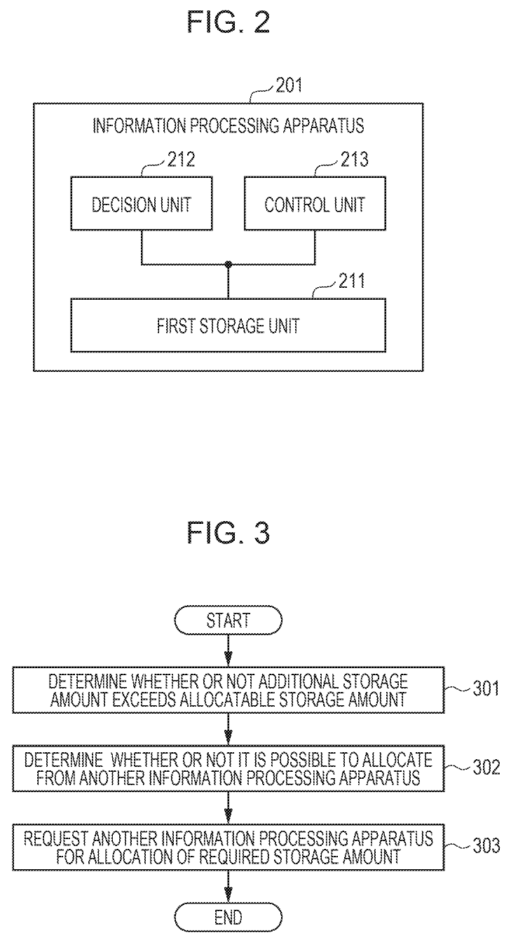

FIG. 2 illustrates an example of a functional configuration of an information processing apparatus of the embodiment. An information processing apparatus 201 in FIG. 2 includes a first storage unit 211, a decision unit 212, and a control unit 213, and allows the VMs to run. The first storage unit 211 stores data used by the VMs.

FIG. 3 is a flowchart illustrating an example of a control process carried out by the information processing apparatus 201 in FIG. 2. First, the decision unit 212 determines whether or not an additional storage amount requested by the VM exceeds an allocatable storage amount for the VM within a storage capacity of the first storage unit 211 (step 301).

In a case where the decision unit 212 determines that the additional storage amount exceeds the allocatable storage amount, the control unit 213 determines whether or not it is possible to allocate a required storage amount, which is equivalent to a shortage in storage amount in the first storage unit 211 to fully allocate the additional storage amount, from a second storage unit in another information processing apparatus (step 302). Then, in a case where the control unit 213 determines that it is possible to allocate the required storage amount from the second storage unit, the control unit 213 requests the another information processing apparatus to allocate the required storage amount (step 303).

According to the information processing apparatus 201 in FIG. 2, in the case where the storage amount of memory used by the VM running in the information processing apparatus 201 becomes insufficient, it is possible for the VM to use the memory of another information processing apparatus.

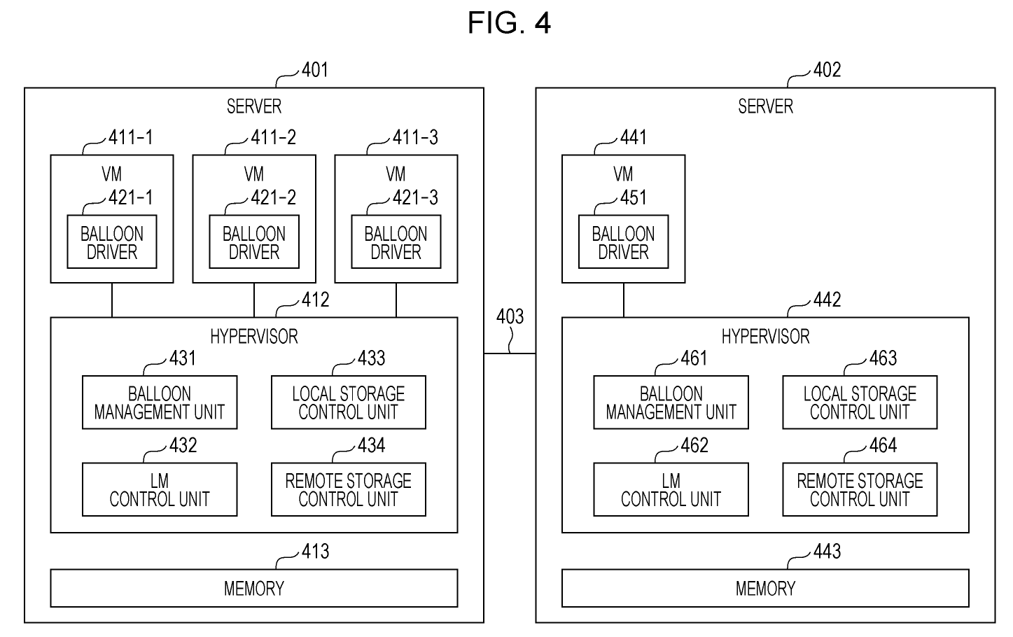

FIG. 4 illustrates an example of a functional configuration of an information processing system including the information processing apparatus 201 in FIG. 2. The information processing system in FIG. 4 includes a server 401 and a server 402. The server 401 includes a memory 413, and the server 402 includes a memory 443. The memory 413 and the memory 443 are physical memories. It is possible for the server 401 to communicate with the server 402 via a communication network 403.

The server 401 corresponds to the information processing apparatus 201 in FIG. 2, and the memory 413 corresponds to the first storage unit 211. The server 402 corresponds to another information processing apparatus, and the memory 443 corresponds to the second storage unit.

In the server 401, a VM 411-1 to a VM 411-3 and a hypervisor 412 are running. Each of the VMs 411-i (i=1 to 3) includes a balloon driver 421-i. The hypervisor 412 includes a balloon management unit 431, a live migration (LM) control unit 432, a local storage control unit 433, and a remote storage control unit 434.

In the server 402, a VM 441 and a hypervisor 442 are running. The VM 441 includes a balloon driver 451. The hypervisor 442 includes a balloon management unit 461, a LM control unit 462, a local storage control unit 463, and a remote storage control unit 464.

The balloon management unit 431 of the server 401 determines whether or not an additional storage amount requested by the balloon driver 421-i exceeds an allocatable storage amount for the VM 411-i within the storage capacity of the memory 413. The allocatable storage amount for the VM 411-i may be a remaining storage amount of the memory 413, or may be a value smaller than the remaining storage amount. In a case where the additional storage amount is equal to or smaller than the allocatable storage amount, the balloon management unit 431 allocates the additional storage amount to the VM 411-i.

In a case where the additional storage amount exceeds the allocatable storage amount, the balloon management unit 431 secures, in the memory 413, a cache area for caching data that the memory 443 of the server 402 stores. Then, the remote storage control unit 434 determines whether or not it is possible to allocate, from the memory 443, a required storage amount, which is equivalent to a shortage in storage amount in the memory 413 to fully allocate the additional storage amount. In a case where it is possible to allocate the required storage amount from the memory 443, the remote storage control unit 434 requests the hypervisor 442 of the server 402 to allocate the required storage amount.

The local storage control unit 463 of the server 402 secures a storage area in the memory 443 for the required storage amount requested from the remote storage control unit 434. Then, the local storage control unit 463 sends, to the remote storage control unit 434, a response indicating that the storage area for the required storage amount has been secured.

The local storage control unit 433 updates a page table entry (PTE) of the memory 413. The PTE is used for conversion between a logical address (virtual physical address) that each VM 411-i uses and a physical address of the memory 413.

The LM control unit 432 monitors a usage time in which the VM 411-i uses the cache area in the memory 413. In a case where the usage time of the cache area exceeds a predetermined time, the LM control unit 432 performs the live migration of the VM 411-i to move the VM 411-i to the server 402.

A function enabled by the balloon management unit 431 corresponds to the processing carried out by the decision unit 212 in FIG. 2, and functions enabled by the LM control unit 432, the local storage control unit 433, and the remote storage control unit 434 correspond to the processing carried out by the control unit 213.

The balloon management unit 461, the LM control unit 462, the local storage control unit 463, and the remote storage control unit 464 of the server 402 are capable of carrying out similar processing to the processing of the balloon control unit 431, the LM control unit 432, the local storage control unit 433, and the remote storage control unit 434.

The number of VMs running in the server 401 or 402 is not limited to one or three, and is sufficient to be an integer of at least one. The information processing system may include three or more servers.

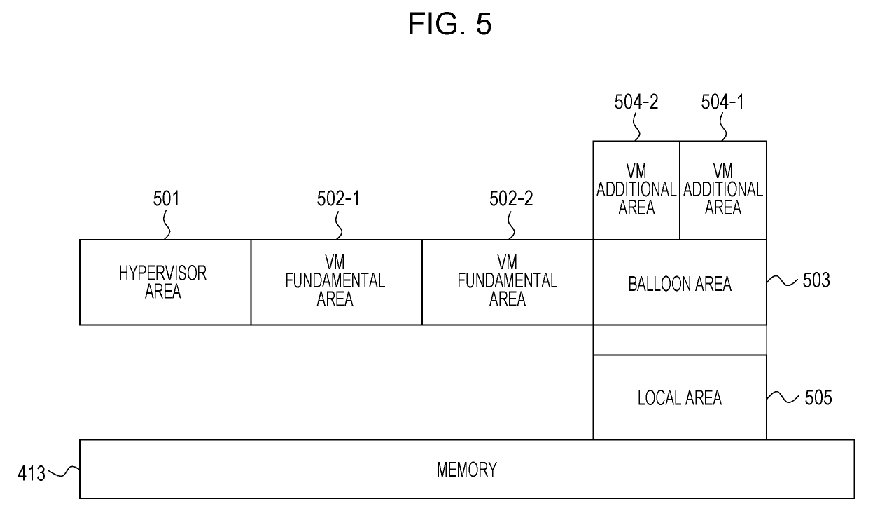

FIG. 5 illustrates an example of a storage area of the memory 413 in a case where only the VM 411-1 and VM 411-2 are running in the server 401. The memory 413 in FIG. 5 includes a hypervisor area 501, a VM fundamental area 502-1, a VM fundamental area 502-2, and a balloon area 503.

The hypervisor area 501 is a storage area used by the hypervisor 412, and the VM fundamental area 502-i (i=1, 2) is a storage area statically allocated to the VM 411-i. The balloon area 503 is a storage area secured by the balloon management unit 431, and includes a VM additional area 504-1 and a VM additional area 504-2. The VM additional area 504-i is dynamically allocated to the VM 411-i by the balloon management unit 431.

In this example, the overall balloon area 503 corresponds to a local area 505. The local area 505 is an area secured between the VMs running in the same server as required. The storage capacity of the memory 413 is 5 gigabytes (GB), and the storage amounts used in each of the areas are as follows.

Hypervisor area 501 comprises 1 GB, VM fundamental area 502-1 comprises 1 GB, VM fundamental area 502-2 comprises 1 GB, VM additional area 504-1 comprises 0.5 GB, VM additional area 504-2 comprises 0.5 GB.

In this case, the total of the storage amounts in use is 4 GB, and the remaining storage amount is 1 GB.

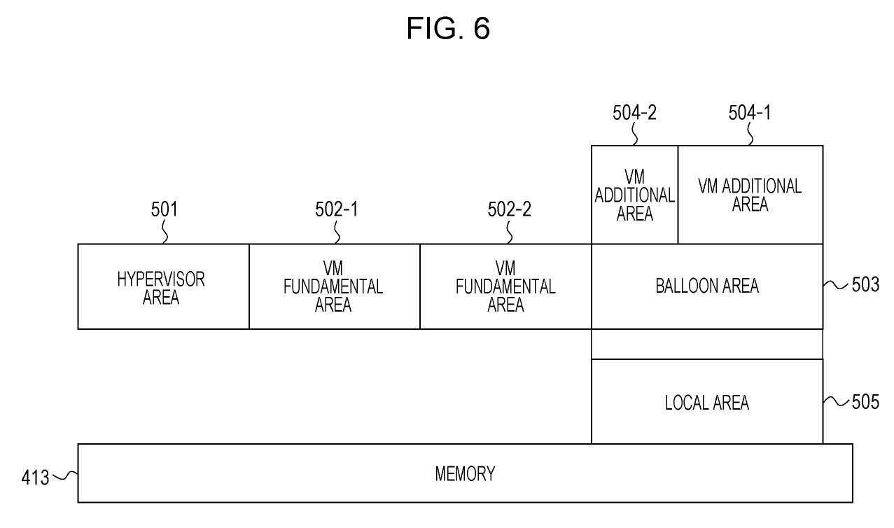

FIG. 6 illustrates an example of the storage area of the memory 413 in a state close to memory exhaustion due to the balloon management unit 431 allocating an additional storage amount of 0.5 GB to the VM 411-1. The storage amounts used in each of the areas in FIG. 6 are as follows.

Hypervisor area 501 comprises 1 GB, VM fundamental area 502-1 comprises 1 GB, VM fundamental area 502-2 comprises 1 GB, VM additional area 504-1 comprises 1 GB, VM additional area 504-2 comprises 0.5 GB.

In this case, the storage amount of the VM additional area 504-1 is increased by 0.5 GB, so that the total of the storage amounts in use is increased to be 4.5 GB and the remaining storage amount is decreased to be 0.5 GB.

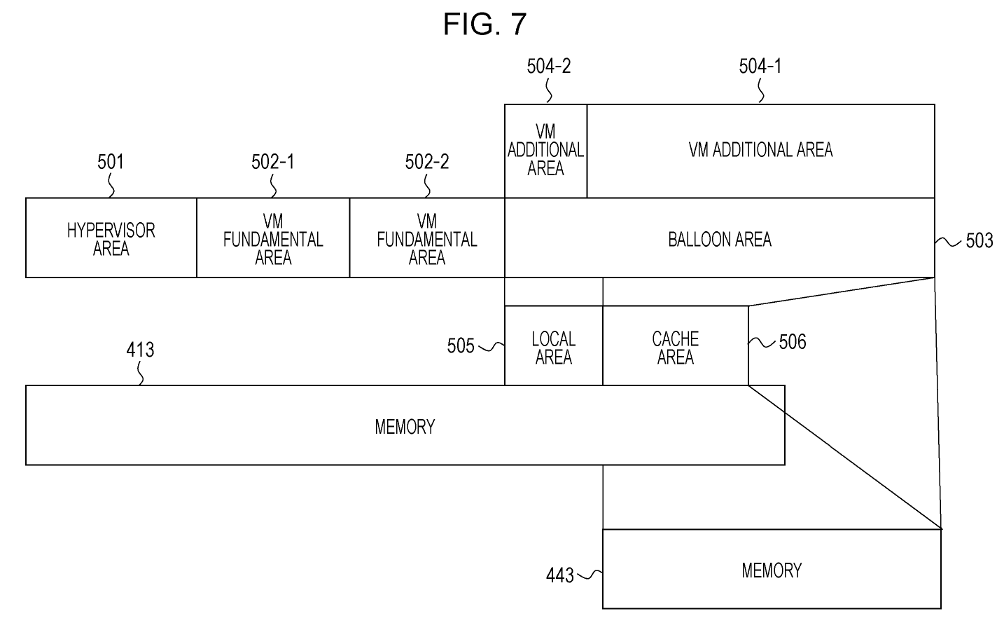

FIG. 7 illustrates an example of the storage area of the memory 413 in a state where memory exhaustion has occurred due to the VM 411-1 further requesting an additional storage amount. The storage amounts used in each of the areas in FIG. 7 are as follows.

Hypervisor area 501 comprises 1 GB, VM fundamental area 502-1 comprises 1 GB, VM fundamental area 502-2 comprises 1 GB, VM additional area 504-1 comprises 2.5 GB, VM additional area 504-2 comprises 0.5 GB.

In this case, the storage amount of the VM additional area 504-1 is further increased by 1.5 GB, so that the total of the storage amounts in use is increased to be 6 GB, which exceeds the storage capacity of the memory 413.

Then, as part of the VM additional area 504-1, a storage area of the memory 443 in the server 402 is allocated, and a cache area 506 is secured in the memory 413. The cache area 506 is an area secured as required between the VMs running in the different servers. The balloon area 503 includes the local area 505 and the cache area 506.

When the VM 411-1 requests access to data in the memory 443, the remote storage control unit 434 accesses the data in the memory 443 via the cache area 506.

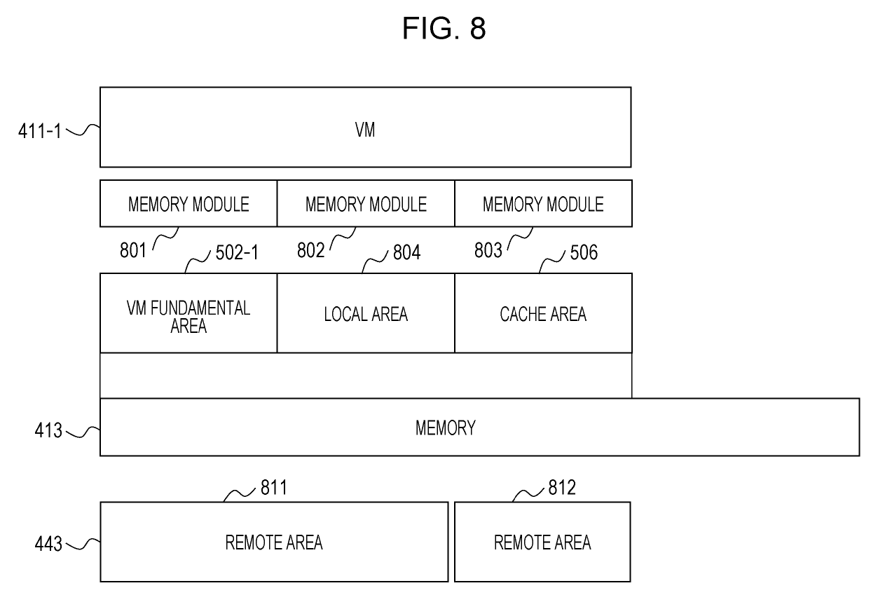

FIG. 8 illustrates an example of a storage area of the memory 413 and memory 443 allocated to the VM 411-1. In this example, the VM fundamental area 502-1, a local area 804, and the cache area 506 are set in memory modules 801 to 803 of the memory 413 in the server 401. The local area 804 corresponds to a storage area allocated to the VM 411-1 within the local area 505 in FIG. 7.

Further, a remote area 811 and a remote area 812 are set in the memory 443 of the server 402. The storage amount of the remote area 811 is equivalent to the total of the storage amounts of the VM fundamental area 502-1 and the local area 804, and the remote area 811 is allocated to the VM 411-1 when the VM 411-1 is moved to the server 402 by live migration.

The storage amount of the remote area 812 corresponds to a required storage amount, which is a shortage of the storage amount in the memory 413, and the VM 411-1 accesses data in the remote area 812 via the cache area 506. As a method by which the VM 411-1 accesses the data in the remote area 812, a memory backend file technique in QEMU, which is a processor emulator, may be applied, for example.

In the memory backend file technique, a file stored in a hard disk is handled as an addressable memory. To be specific, addresses in the cache area in the memory are used as addresses in the file, and when a specific address is accessed, data of the corresponding storage area is transferred to the memory from the file in the hard disk.

By replacing the hard disk in this technique with the memory 443 of the server 402, when a specific address in the cache area 506 is accessed, it is possible to transfer the data of the corresponding storage area within the memory 443 to the cache area 506.

According to the information processing system in FIG. 4, in a case where a memory exhaustion warning is issued in the server 401, it is possible for the VM 411-i to use the memory 443 of the server 402. This makes it possible for the VM 411-1 to VM 411-3 to run continuously without being forcibly terminated.

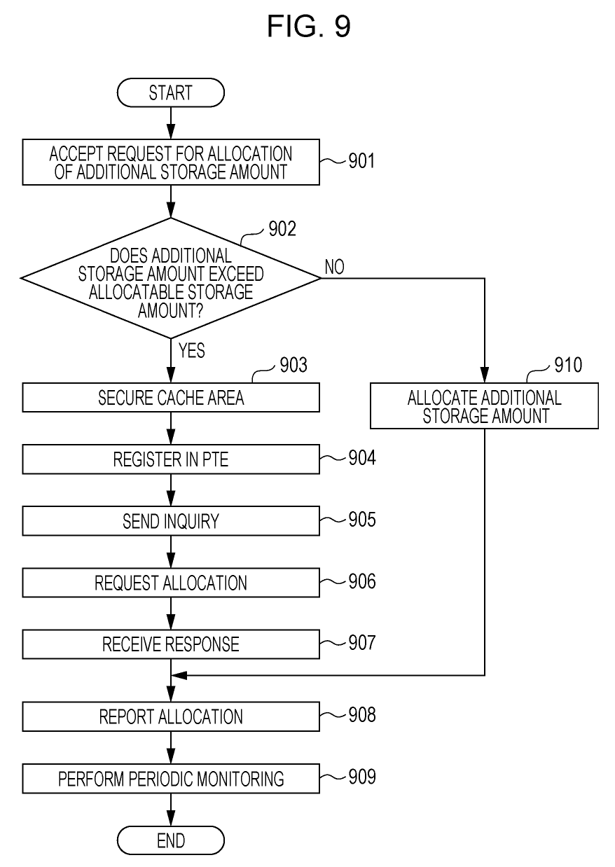

FIG. 9 is a flowchart illustrating a specific example of a control process carried out by the hypervisor 412 in FIG. 4. First, the balloon management unit 431 accepts an allocation request for an additional storage amount from the balloon driver 421-i of the VM 411-i (step 901), and determines whether or not the additional storage amount exceeds an allocatable storage amount from the memory 413 (step 902). For example, in a case where the total of the storage amount of the current balloon area 503 and the additional storage amount exceeds a balloon warning value, the balloon management unit 431 may determine that the additional storage amount exceeds the allocatable storage amount.

In the case where the additional storage amount exceeds the allocatable storage amount (step 902, YES), the balloon management unit 431 allocates the allocatable storage amount from the memory 413 to the VM 411-i and secures a cache area in the memory 413 (step 903). Subsequently, the local storage control unit 433 registers a logical address of the cache area in the PTE that the VM 411-i uses (step 904).

Next, the remote storage control unit 434 sends an inquiry indicating the required storage amount to the hypervisor 442 of the server 402 (step 905). The required storage amount is equivalent to a difference between the additional storage amount and the storage amount having been allocated from the memory 413.

The balloon management unit 461 of the hypervisor 442 sends a response indicating whether or not it is possible to allocate the required storage amount from the memory 443, to the remote storage control unit 434. Then, the remote storage control unit 434 determines whether or not it is possible to allocate the required storage amount from the memory 443 based on the response received from the hypervisor 442.

In a case where the remote storage control unit 434 determines that it possible to allocate the required storage amount from the memory 443, the remote storage control unit 434 requests the hypervisor 442 to allocate the required storage amount (step 906). Then, the balloon management unit 461 allocates the required storage amount to the VM 411-i from the memory 443, and the local storage control unit 463 registers a logical address of the allocated storage area in the PTE that the VM-411-i uses.

Next, the remote storage control unit 434 receives, from the hypervisor 442, a response indicating that the storage area for the required storage amount has been secured (step 907). Subsequently, the balloon management unit 431 reports, to the balloon driver 421-i, that the additional storage amount has been allocated (step 908), and the local storage control unit 433 performs periodic monitoring of the memory 413 (step 909).

In a case where the additional storage amount is equal to or smaller than the allocatable storage amount (step 902, NO), the balloon management unit 431 allocates the additional storage amount to the VM 411-i from the memory 413 (step 910). Then, the local storage control unit 433 carries out the processing from step 908 on.

According to the control process in FIG. 9, the remote storage control unit 434 may determine, by sending an inquiry to the hypervisor 442 in step 905, whether or not it is possible to allocate the required storage amount from the memory 443.

Note that the remote storage control unit 434 may also send an inquiry indicating a used storage amount including the required storage amount in place of the inquiry indicating the required storage amount. As the used storage amount, the total of the storage amounts of the remote area 811 and the remote area 812 illustrated in FIG. 8 may be used, for example.

In this case, the remote storage control unit 434 determines whether or not it is possible to allocate the used storage amount from the memory 443 based on the response received from the hypervisor 442. Then, in a case where the remote storage control unit 434 determines that it possible to allocate the used storage amount, the remote storage control unit 434 requests the hypervisor 442 to allocate the used storage amount.

By allocating the used storage amount, which is the total of the storage amounts of the remote area 811 and the remote area 812, in advance from the memory 443, it is possible to carry out the live migration of the VM 411-i quickly.

In the case where the information processing system includes three or more servers, the remote storage control unit 434 sends an inquiry to the hypervisor of each of the servers, and determines, based on a response received from each of the servers, the server to which a request for the allocation of the required storage amount is to be sent.

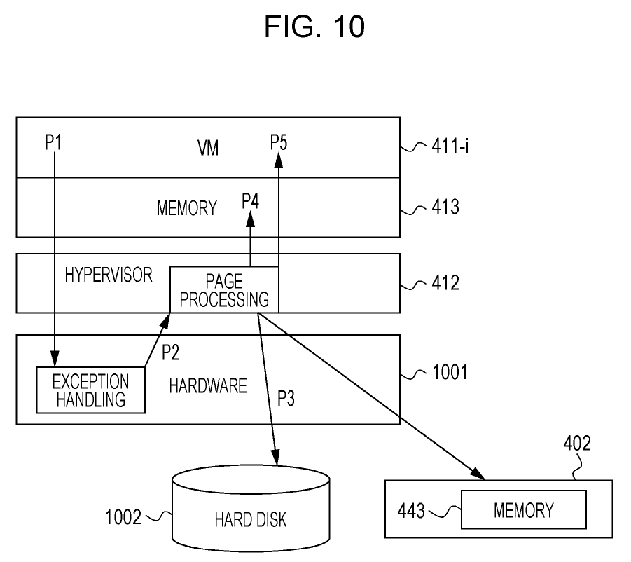

FIG. 10 illustrates an example of a reading-out control process carried out by the hypervisor 412 when the VM 411-i reads out data from the memory 443 of the server 402. The reading-out control process in FIG. 10 is carried out in the following procedure.

P1: The VM 411-i issues a reading-out request including a logical address corresponding to a hard disk 1002 of the server 401 or the memory 443 of the server 402, and then a page fault (page exception) occurs in hardware 1001 inside the server 401.

P2: An exception handling is carried out by the hardware 1001, and the process moves to page processing by the remote storage control unit 434 of the hypervisor 412. The remote storage control unit 434 checks identification information of the VM 411-i and the logical address included in the reading-out request.

P3: In a case where the logical address corresponds to the hard disk 1002, the remote storage control unit 434 reads out data from the hard disk 1002. On the other hand, in a case where the logical address corresponds to the memory 443, the remote storage control unit 434 reads out data from the memory 443.

P4: The remote storage control unit 434 writes the data read out from the hard disk 1002 or the memory 443 in the cache area within the memory 413, and the local storage control unit 433 updates the PTE.

P5: The local storage control unit 433 reports, to the VM 411-i, the logical address of the cache area in which the data has been written, and then the VM 411-i reads out the data from the cache area using the reported logical address.

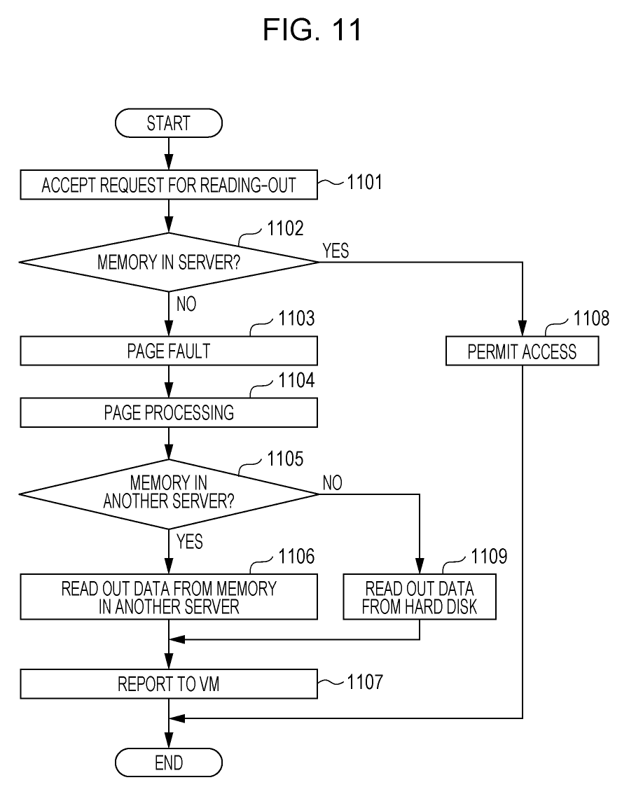

FIG. 11 is a flowchart illustrating an example of the reading-out control process in FIG. 10. First, the local storage control unit 433 accepts a reading-out request from the VM 411-i, converts a logical address included in the reading-out request to a physical address using the PTE, and transfers the physical address to the hardware 1001 (step 1101).

The hardware 1001 determines whether or not the physical address corresponds to the memory 413 (step 1102), and in a case where the physical address corresponds to the memory 413 (step 1102, YES), the hardware 1001 permits the access to the physical address (step 1108).

On the other hand, in a case where the physical address does not correspond to the memory 413 (step 1102, NO), a page fault is caused to occur (step 1103). Then, the remote storage control unit 434 carries out page processing (step 1104) and checks whether or not the logical address included in the access request corresponds to the memory 443 (step 1105).

In a case where the logical address corresponds to the memory 443 (step 1105, YES), the remote storage control unit 434 reads out data from the memory 443, and writes the data having been read out into the cache area within the memory 413 (step 1106). Then, the local storage control unit 433 registers, in the PTE, the logical address and the physical address of the data written in the cache area.

Subsequently, the local storage control unit 433 reports the logical address of the written data to the VM 411-i (step 1107).

On the other hand, in a case where the logical address corresponds to the hard disk 1002 (step 1105, NO), the remote storage control unit 434 reads out data from the hard disk 1002, and writes the data having been read out into the cache area within the memory 413 (step 1109). Then, the local storage control unit 433 registers, in the PTE, the logical address and the physical address of the data written in the cache area, and the remote storage control unit 434 carries out the processing in step 1107.

Also in a case where the VM 411-i writes data in the memory 443 of the server 402, the hypervisor 412 carries out a writing-in control process in a similar manner to that in FIG. 10 and FIG. 11.

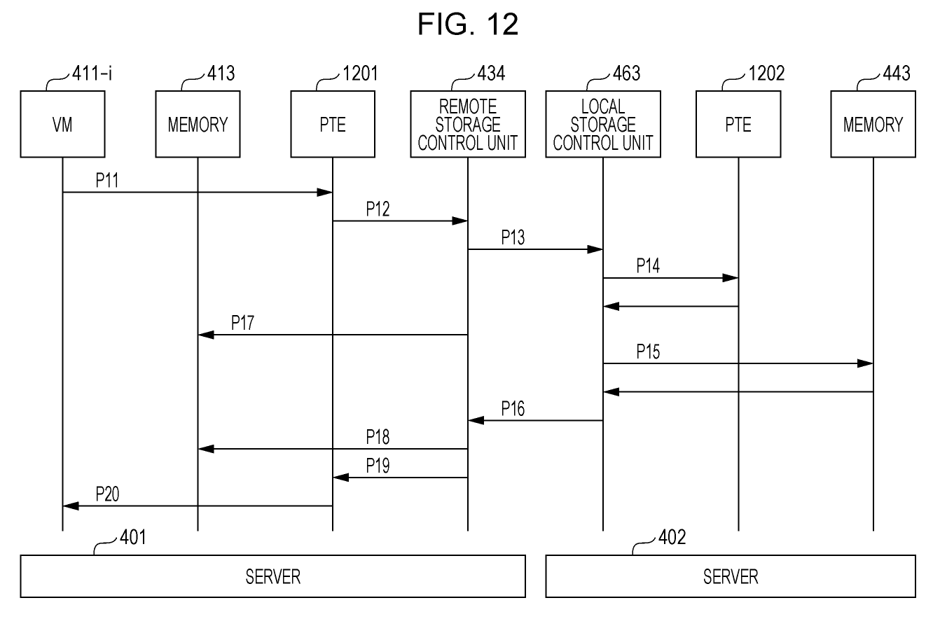

FIG. 12 illustrates an example of a sequence of the reading-out control process carried out by the hypervisor 412. The reading-out control process in FIG. 12 is carried out in the following procedure.

P11: The VM 411-i of the server 401 transfers a reading-out request including a logical address corresponding to the memory 443 of the server 402, and the local storage control unit 433 converts the logical address to a physical address using a PTE 1201. In a case where the physical address corresponds to the cache area within the memory 413, the local storage control unit 433 reads out data (reading-out data) from the cache area and transfers it to the VM 411-i.

P12: In a case where the physical address does not correspond to the memory 413, a page fault occurs.

P13: The remote storage control unit 434 sends, to the local storage control unit 463 of the server 402, a remote reading-out request including the logical address included in the reading-out request.

P14: The local storage control unit 463 converts the logical address included in the remote reading-out request to a physical address using a PTE 1202.

P15: The local storage control unit 463 accesses the memory 443 using the physical address, and reads out data (reading-out data) from the memory 443.

P16: The local storage control unit 463 sends the reading-out data to the remote storage control unit 434.

P17: The remote storage control unit 434 acquires a cache area within the memory 413.

P18: The remote storage control unit 434 writes the reading-out data received from the local storage control unit 463 into the cache area.

P19: The local storage control unit 433 registers, in the PTE 1201, the logical address and the physical address of the reading-out data written in the cache area.

P20: The local storage control unit 433 reports the logical address of the reading-out data to the VM 411-i.

According to the reading-out control process in FIG. 12, it is possible for the VM 411-i to read out data from the memory 443 of the server 402 via the cache area within the memory 413.

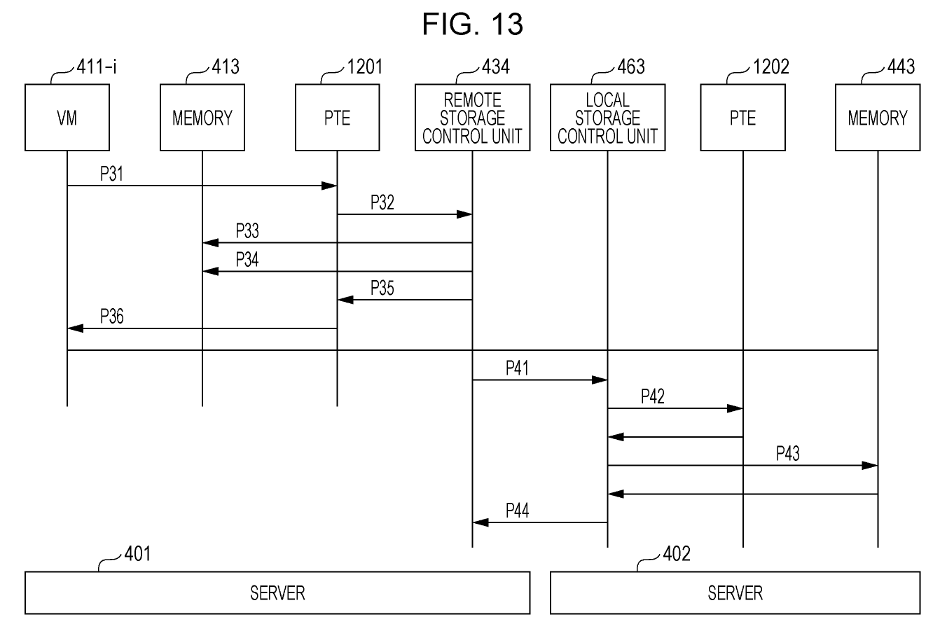

FIG. 13 illustrates an example of a sequence of the writing-in control process carried out by the hypervisor 412. The writing-in control process in FIG. 13 is carried out in the following procedure.

P31: The VM 411-i of the server 401 transfers a writing-in request including a logical address corresponding to the memory 443 of the server 402, and the local storage control unit 433 converts the logical address to a physical address using the PTE 1201. In a case where the physical address corresponds to the cache area within the memory 413, the local storage control unit 433 writes writing-in data in the cache area and reports the completion of writing-in to the VM 411-i.

P32: In a case where the physical address does not correspond to the memory 413, a page fault occurs.

P33: The remote storage control unit 434 acquires a cache area within the memory 413.

P34: The remote storage control unit 434 writes the writing-in data in the cache area.

P35: The local storage control unit 433 registers, in the PTE 1201, the logical address and the physical address of the writing-in data written in the cache area.

P36: The local storage control unit 433 reports the completion of writing-in and the logical address of the writing-in data, to the VM 411-i.

Thereafter, in the background, the writing-in data is transferred from the server 401 to the server 402 in the following procedure.

P41: The remote storage control unit 434 sends the logical address included in the writing-in request and the writing-in data, to the local storage control unit 463 of the server 402.

P42: The local storage control unit 463 converts the received logical address to a physical address using the PTE 1202.

P43: The local storage control unit 463 accesses the memory 443 using the physical address, and writes the writing-in data in the memory 443.

P44: The local storage control unit 463 reports the completion of writing-in to the remote storage control unit 434.

According to the writing-in control process in FIG. 13, it is possible for the VM 411-i to write data into the memory 443 of the server 402 via the cache area within the memory 413.

Note that, when the writing-in data is transferred from the server 401 to the server 402, it is possible to use update information indicating updated portions of the storage area in the memory 413. In this case, a bitmap indicating whether or not each of multiple portions in the memory 413 is updated, is used as the update information. The multiple portions may be multiple pages.

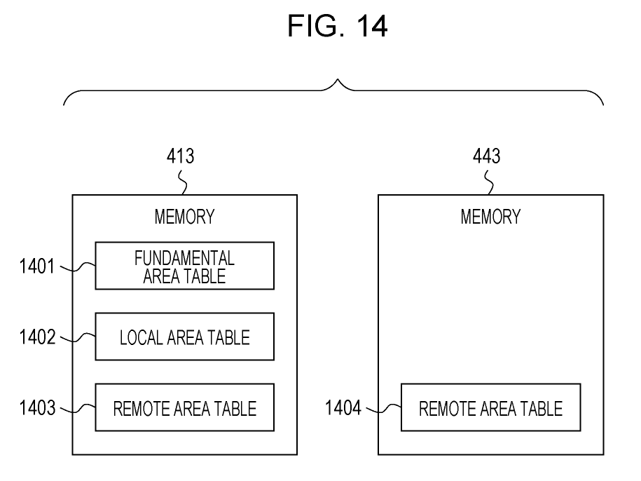

FIG. 14 illustrates an example of update information for the VM 411-i. When a cache area for the VM 411-i is secured in the memory 413, the local storage control unit 433 of the server 401 generates a fundamental area table 1401, a local area table 1402, and a remote area table 1403.

The fundamental area table 1401 is update information of the VM fundamental area in the memory 413, the local area table 1402 is update information of the local area in the VM additional area, and the remote area table 1403 is update information of the cache area in the VM additional area.

The local storage control unit 463 of the server 402 generates a remote area table 1404. The remote area table 1404 is update information of the storage area of the memory 443 allocated to the VM 411-i.

When data of the memory 413 or memory 443 is updated, a bit of the update information corresponding to the updated portion is set to a logical value of “1” (ON). The bit that is set to ON is called a “dirty bit” in some cases.

The fundamental area table 1401 and the local area table 1402 are used when the live migration of the VM 411-i is carried out. Meanwhile, the remote area table 1403 and the remote area table 1404 are used when writing-in data is transferred from the server 401 to the server 402.

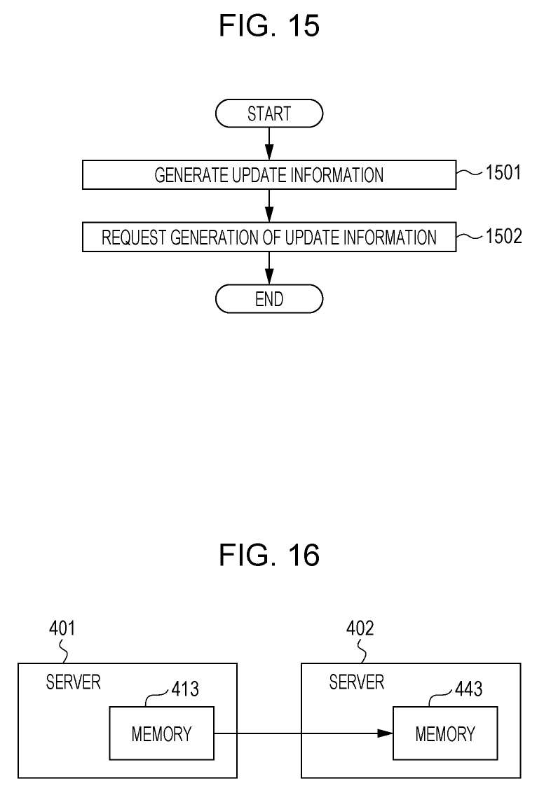

FIG. 15 is a flowchart illustrating an example of an update information generation process. The update information generation process in FIG. 15 is carried out in step 906 in FIG. 9, for example. First, the local storage control unit 433 generates, as update information of the memory 413, the fundamental area table 1401, the local area table 1402, and the remote area table 1403 (step 1501).

Next, the local storage control unit 433 requests the local storage control unit 463 to generate update information of the memory 443 (step 1502), and the local storage control unit 463 generates the remote area table 1404.

In P34 in FIG. 13, the local storage control unit 433 changes a bit of the remote area table 1403 corresponding to a portion into which writing-in data has been written within the cache area to a dirty bit. With this, information indicating that the cache area has been updated, is recorded in the remote area table 1403.

The remote storage control unit 434 checks the remote area table 1403 at a set interval. In the case where a dirty bit is set in the remote area table 1403, the remote storage control unit 434 reads out data of the portion corresponding to the dirty bit from the cache area in P41, and sends it to the local storage control unit 463. Then, the local storage control unit 433 changes the dirty bit to a logical value of “0” (OFF). With this, the information indicating that the cache area has been updated, is reset.

In P43, the local storage control unit 463 changes a bit of the remote area table 1404 corresponding to a portion into which the writing-in data has been written in the memory 443 to a dirty bit. With this, information indicating that the storage area of the memory 443 has been updated, is recorded in the remote area table 1404.

Using the update information in FIG. 14 makes it possible to manage an update state of the memory space of each VM 411-i in real time. This makes it possible to transfer the writing-in data in the cache area from the server 401 to the server 402 in the background, and carry out the live migration of the VM 411-i at a desired timing.

FIG. 16 illustrates an example of the live migration of the VM 411-i. The live migration of the VM 411-i is carried out in a case where the usage time of the cache area by the VM 411-i exceeds a predetermined time.

The live migration of the VM 411-i may be any of a pre live migration and a post live migration. In the case of the pre live migration, data in the memory 413 is copied into the memory 443, and then CPU control information of the VM 411-i is transferred to the hypervisor 442. The CPU control information is control information indicating a state of progress or the like of the processing carried out by the VM 411-i. On the other hand, in the case of the post live migration, the CPU control information of the VM 411-i is transferred to the hypervisor 442, and then data in the memory 413 is copied into the memory 443.

The pre live migration is carried out in the following procedure, for example.

The LM control unit 432 changes all the bits of the fundamental area table 1401 and the local area table 1402 to dirty bits.

The LM control unit 432 reads out data of the portions corresponding to the dirty bits from the memory 413 in sequence and transfers the read data to the LM control unit 462, and the LM control unit 462 writes the received data into the memory 443. The LM control unit 432 repeats the data transfer until the number of dirty bits is decreased to be equal to or smaller than a threshold.

When the number of dirty bits is decreased to be equal to or smaller than the threshold, the LM control unit 432 causes the VM 411-i to stop running temporarily, and transfers the CPU control information and the data of the remaining portions to the LM control unit 462.

The LM control unit 462 makes the VM 411-i restart the operation in the server 402 using the received CPU control information.

Meanwhile, the post live migration is carried out in the following procedure, for example.

The LM control unit 432 causes the VM 411-i to stop running temporarily.

The LM control unit 432 transfers the CPU control information to the LM control unit 462.

The LM control unit 462 makes the VM 411-i restart the operation in the server 402 using the received CPU control information.

The LM control unit 432 reads out data of the portions accessed by the VM 411-i from the memory 413 on demand and transfers it to the LM control unit 462, and transfers the data of the remaining portions to the LM control unit 462 at the same time. The LM control unit 462 writes the received data into the memory 443.

The balloon management unit 431 records the last access time with respect to the cache area used by each VM 411-i. Then, when an unused storage amount in the balloon area is decreased to be equal to or smaller than a predetermined value, the balloon management unit 431 deletes the cache areas in the order of the last access time from oldest to latest. This makes it possible to secure new cache areas in the memory 413.

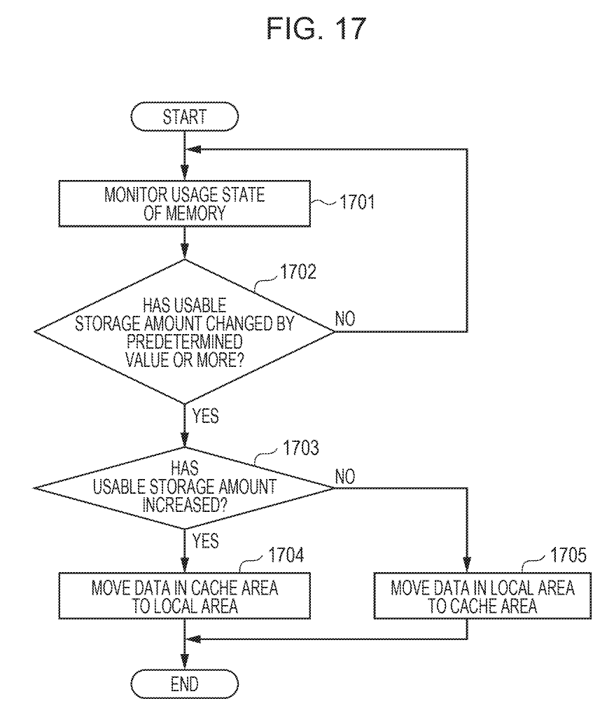

FIG. 17 is a flowchart illustrating an example of a periodic monitoring process in step 909 in FIG. 9. First, the local storage control unit 433 monitors a usage state of the memory 413 at a set interval (step 1701), and checks whether or not the storage amount usable as the local area by the balloon management unit 431 has changed in size by equal to or more than a predetermined value (step 1702). In a case where the change in size of the usable storage amount is less than the predetermined value (step 1702, NO), the local storage control unit 433 repeats the processing in step 1701 and the processing in step 1702.

On the other hand, in a case where the change in size of the usable storage amount is equal to or more than the predetermined value (step 1702, YES), the local storage control unit 433 checks whether or not the usable storage amount has increased (step 1703). In a case where the usable storage amount has increased (step 1703, YES), the local storage control unit 433 causes the data in the cache area to be moved to the local area (step 1704).

On the other hand, in a case where the usable storage amount has decreased (step 1703, NO), the local storage control unit 433 causes the data in the local area to be moved to the cache area (step 1705).

The configuration of the server 101 in FIG. 1 is merely an example, and part of the constituent elements may be omitted or modified in accordance with usage or conditions of the server 101.

The configuration of the information processing apparatus 201 in FIG. 2 is merely an example, and part of the constituent elements may be omitted or modified in accordance with usage or conditions of the information processing apparatus 201.

The configuration of the information processing system in FIG. 4 is merely an example, and part of the constituent elements may be omitted or modified in accordance with usage or conditions of the information processing system. For example, the information processing system may include three or more servers.

The flowcharts in FIG. 3, FIG. 9, FIG. 11, FIG. 15, and FIG. 17 are merely examples, and part of the processes may be omitted or modified in accordance with the configuration or conditions of the information processing system. For example, in a case where it is not required to move data between the local area and the cache area, the periodic monitoring process in step 909 in FIG. 9 may be omitted.

The storage areas illustrated in FIG. 5 to FIG. 8 are merely examples, and the storage area allocation results change depending on the number of VMs in operation and the loads. The reading-out control processes in FIG. 10 and FIG. 12, and the writing-in control process in FIG. 13 are merely examples, and these control processes are changed in accordance with the configuration or conditions of the information processing system.

The update information in FIG. 14 is merely an example, and the update information is changed in accordance with the configuration or conditions of the information processing system. The live migration in FIG. 16 is merely an example, and the server from which the VM moves and the server to which the VM moves change depending on the configuration or conditions of the information processing system.

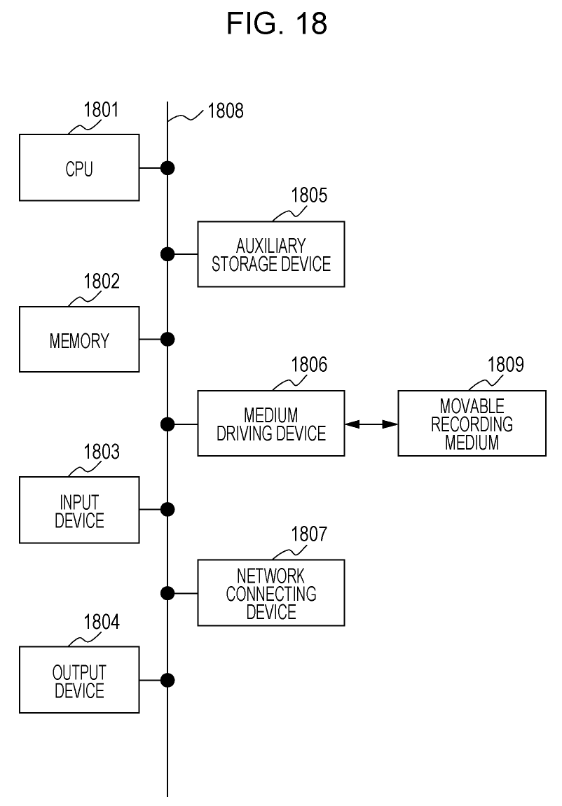

FIG. 18 illustrates a hardware configuration of an information processing apparatus (computer) that is used as the information processing apparatus 201 in FIG. 2, or the server 401 or 402 in FIG. 4. The information processing apparatus in FIG. 18 includes a CPU 1801, a memory 1802, an input device 1803, an output device 1804, an auxiliary storage device 1805, a medium driving device 1806, and a network connecting device 1807. These constituent elements are connected to one another through a bus 1808.

The memory 1802 is, for example, a semiconductor memory such as a read only memory (ROM), a random access memory (RAM) or flash memory, and stores programs and data used in carrying out the processes. The memory 1802 may be used as the first storage unit 211 in FIG. 2, or the memory 413 or 443 in FIG. 4.

The CPU 1801 (processor) operates as the decision unit 212 and the control unit 213 in FIG. 2 by executing the programs while making use of the memory 1802.

The CPU 1801, by executing the programs while making use of the memory 1802, causes the VM 411-1 to VM 411-3 and the hypervisor 412 in FIG. 4 to run. The CPU 1801 also causes the balloon driver 421-1 to balloon driver 421-3 to run by executing the programs. The CPU 1801, by executing the programs, also causes the balloon management unit 431, the LM control unit 432, the local storage control unit 433, and the remote storage control unit 434 to run.

The CPU 1801 also causes, by executing the programs, the VM 441 and the hypervisor 442 to run. The CPU 1801, by executing the programs, also causes the balloon driver 451, the balloon management unit 461, the LM control unit 462, the local storage control unit 463, and the remote storage control unit 464 to run.

The input device 1803 is, for example, a keyboard, a pointing device or the like, and is used for the input of commands or information from an operator or a user. The output device 1804 is, for example, a display device, a printer, a speaker or the like, and is used for the output of inquiries or commands to the operator or the user, and the process results.

The auxiliary storage device 1805 is, for example, a magnetic disk drive, an optical disk drive, a magneto-optical disk drive, a tape drive, or the like. The auxiliary storage device 1805 may be a hard disk drive. The information processing apparatus may store programs and data in the auxiliary storage device 1805 beforehand, and may use the programs and the data by loading them in the memory 1802.

The medium driving device 1806 drives a movable recording medium 1809, and accesses the recording contents thereof. The movable recording medium 1809 is a memory device, a flexible disk, an optical disk, a magneto-optical disk, or the like. The movable recording medium 1809 may be a compact disk read only memory (CD-ROM), a digital versatile disk (DVD), a Universal Serial Bus (USB) memory, or the like. An operator or a user may store programs and data in this movable recording medium 1809 beforehand, and may use the programs and the data by loading them in the memory 1802.

As discussed above, the computer-readable recoding medium storing the programs and data used in the processes is a physical (not temporary) recording medium such as the memory 1802, the auxiliary storage device 1805, or the movable recording medium 1809.

The network connecting device 1807 is a communication interface circuit that is connected to a communication network such as a local area network (LAN) or a wide area network (WAN), and performs data conversion along with communication. The information processing apparatus communicates with another information processing apparatus via the network connecting device 1807. The information processing apparatus may receive programs and data from an external device via the network connecting device 1807, and may use the received programs and data by loading them in the memory 1802 as well.

Not all of the constituent elements illustrated in FIG. 18 are required to be included in the information processing apparatus, and it is also possible to omit part of the constituent elements in accordance with the usage or conditions. For example, in a case where an interface with a user or an operator is not required to be provided, the input device 1803 and the output device 1804 may be omitted. Further, in a case where the movable recording medium 1809 is not used, the medium driving deice 1806 may be omitted.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing apparatus comprising:
a first memory for storing data to be used by a virtual machine; and
a processor coupled to the first memory and the processor configured to:
determine whether an additional storage amount requested by the virtual machine exceeds an allocatable storage amount for the virtual machine within a storage capacity of the first memory;
determine, in a case where it is determined that the additional storage amount exceeds the allocatable storage amount, whether it is possible to allocate a required storage amount from a second memory in another information processing apparatus, wherein the required storage amount is equivalent to a shortage in storage amount in the first memory to fully allocate the additional storage amount; and
request the another information processing apparatus to allocate the required storage amount in a case where it is determined that it is possible to allocate the required storage amount from the second memory.

2. The information processing apparatus according to claim 1, wherein
the processor is further configured to:
send an inquiry that indicates the required storage amount to a hypervisor that runs in the another information processing apparatus;
determine whether it is possible to allocate the required storage amount from the second memory based on a response received from the hypervisor; and
request the hypervisor to allocate the required storage amount in a case where it is determined that it is possible to allocate the required storage amount from the second memory.

3. The information processing apparatus according to claim 1, wherein
the processor is further configured to:
send an inquiry that indicates a used storage amount that includes the required storage amount to a hypervisor that runs in the another information processing apparatus;
determine whether it is possible to allocate the used storage amount from the second memory based on a response received from the hypervisor; and
request the hypervisor to allocate the used storage amount in a case where it is determined that it is possible to allocate the used storage amount from the second memory.

4. The information processing apparatus according to claim 2, wherein
the processor is further configured to:
request the hypervisor to read out data requested by the virtual machine in a case where a logical address of the read out data corresponds to a storage area in the second memory;
receive the read out data from the hypervisor;
write the received read out data in a cache area within the first memory; and
report a logical address of the read out data in the cache area to the virtual machine.

5. The information processing apparatus according to claim 2, wherein
the first memory includes a first storage area allocated to the virtual machine and a cache area for caching data that is stored in a second storage area within the second memory allocated to the virtual machine, and
the processor is further configured to:
generate first update information that indicates an updated portion of the first storage area and second update information that indicates an updated portion of the cache area in a case where it is determined that the additional storage amount exceeds the allocatable storage amount;
write writing-in data issued by the virtual machine in the cache area in a case where a logical address of the writing-in data corresponds to the second storage area;
record information that indicates that the cache area has been updated in the second update information;
report a logical address of the writing-in data in the cache area to the virtual machine; and
send the writing-in data in the cache area and the logical address of the writing-in data in the cache area to the hypervisor based on the second update information.

6. The information processing apparatus according to claim 5, wherein
the processor is further configured to:
record in the first update information, in a case where the virtual machine is moved to the another information processing apparatus, information that indicates that the overall first storage area has been updated; and
send data in the first storage area and control information of the virtual machine to the hypervisor based on the first update information.

7. An information processing system comprising:
a first information processing apparatus including:
a first memory for storing data to be used by a virtual machine that runs in the first information processing apparatus; and
a first processor coupled to the first memory; and
a second information processing apparatus including:
a second memory; and
a second processor coupled to the second memory,
wherein
the first processor is configured to:
determine whether an additional storage amount requested by the virtual machine exceeds an allocatable storage amount for the virtual machine within a storage capacity of the first memory;
determine, in a case where it is determined that the additional storage amount exceeds the allocatable storage amount, whether it is possible to allocate a required storage amount from the second memory, wherein the required storage amount is equivalent to a shortage in storage amount in the first memory to fully allocate the additional storage amount; and
request the second information processing apparatus to allocate the required storage amount in a case where it is determined that it is possible to allocate the required storage amount from the second memory.

8. The information processing system according to claim 7, wherein
the first processor is further configured to:
send an inquiry that indicates the required storage amount to the second processor;
determine whether it is possible to allocate the required storage amount from the second memory based on a response received from the second processor; and
request the second processor to allocate the required storage amount in a case where it is determined that it is possible to allocate the required storage amount from the second memory.

9. The information processing system according to claim 7, wherein
the first processor is further configured to:
send an inquiry that indicates a used storage amount that includes the required storage amount to the second processor;
determine whether it is possible to allocate the used storage amount from the second memory based on a response received from the second processor; and
request the second processor to allocate the used storage amount in a case where it is determined that it is possible to allocate the used storage amount from the second memory.

10. The information processing system according to claim 8, wherein
the first processor is further configured to:
request the second processor for reading-out data requested by the virtual machine in a case where a logical address of the reading-out data corresponds to a storage area in the second memory;
receive the reading-out data from the second processor;
write the received reading-out data in a cache area within the first memory; and
report a logical address of the reading-out data in the cache area to the virtual machine.

11. The information processing system according to claim 8, wherein
the first memory includes a first storage area allocated to the virtual machine and a cache area for caching data that is stored in a second storage area within the second memory allocated to the virtual machine, and
the first processor is further configured to:
generate first update information that indicates an updated portion of the first storage area and second update information that indicates an updated portion of the cache area in a case where it is determined that the additional storage amount exceeds the allocatable storage amount;
write writing-in data issued by the virtual machine in the cache area in a case where a logical address of the writing-in data corresponds to the second storage area;
record information that indicates that the cache area has been updated in the second update information;
report a logical address of the writing-in data in the cache area to the virtual machine; and
send the writing-in data in the cache area and the logical address of the writing-in data in the cache area to the second processor based on the second update information.

12. The information processing system according to claim 11, wherein
the first processor is further configured to:
record in the first update information, in a case where the virtual machine is moved to the second information processing apparatus, information that indicates that the overall first storage area has been updated; and
send data in the first storage area and control information of the virtual machine to the second processor based on the first update information.

13. A non-transitory computer-readable recording medium having stored therein a program that causes a computer to execute a process, the process comprising:
determining whether an additional storage amount requested by a virtual machine exceeds an allocatable storage amount for the virtual machine within a storage capacity of a first memory in the computer;
determining, in a case where it is determined that the additional storage amount exceeds the allocatable storage amount, whether it is possible to allocate a required storage amount from a second memory in another computer, wherein the required storage amount is equivalent to a shortage in storage amount in the first memory to fully allocate the additional storage amount; and
requesting the another computer to allocate the required storage amount in a case where it is determined that it is possible to allocate the required storage amount from the second memory.

14. The non-transitory computer-readable recording medium according to claim 13, the process further comprising:
sending an inquiry that indicates the required storage amount to a hypervisor that runs in the another computer;
determining whether it is possible to allocate the required storage amount from the second memory based on a response received from the hypervisor; and
requesting the hypervisor to allocate the required storage amount in a case where it is determined that it is possible to allocate the required storage amount from the second memory.

15. The non-transitory computer-readable recording medium according to claim 13, the process further comprising:
sending an inquiry that indicates a used storage amount that includes the required storage amount to a hypervisor that runs in the another computer;
determining whether it is possible to allocate the used storage amount from the second memory based on a response received from the hypervisor; and
requesting the hypervisor to allocate the used storage amount in a case where it is determined that it is possible to allocate the used storage amount from the second memory.

16. The non-transitory computer-readable recording medium according to claim 14, the process further comprising:
requesting the hypervisor for reading-out data requested by the virtual machine in a case where a logical address of the reading-out data corresponds to a storage area in the second memory;
receiving the reading-out data from the hypervisor;
writing the received reading-out data in a cache area within the first memory; and
reporting a logical address of the reading-out data in the cache area to the virtual machine.

17. The non-transitory computer-readable recording medium according to claim 14, wherein
the first memory includes a first storage area allocated to the virtual machine and a cache area for caching data that is stored in a second storage area within the second memory allocated to the virtual machine, and
the process further comprises:
generating first update information that indicates an updated portion of the first storage area and second update information that indicates an updated portion of the cache area in a case where it is determined that the additional storage amount exceeds the allocatable storage amount;
writing writing-in data issued by the virtual machine in the cache area in a case where a logical address of the writing-in data corresponds to the second storage area;
recording information that indicates that the cache area has been updated in the second update information;
reporting a logical address of the writing-in data in the cache area to the virtual machine; and
sending the writing-in data in the cache area and the logical address of the writing-in data in the cache area to the hypervisor based on the second update information.

18. The non-transitory computer-readable recording medium according to claim 17, the process further comprising:
recording in the first update information, in a case where the virtual machine is moved to the another computer, information that indicates that the overall first storage area has been updated; and
sending data in the first storage area and control information of the virtual machine to the hypervisor based on the first update information.
